(19) United States
(12) Patent Application Publication
(10) Pub. No.: US 2025/0284010 A1
(43) Pub. Date: Sep. 11, 2025

(54) AUTHENTICATION OF POSITION, NAVIGATION, AND TIMING (PNT) MEASUREMENTS AND SOLUTIONS VIA VALIDATRED MEASUREMENTS AND SOLUTIONS

(71) Applicant: Satelles, Inc., Reston, VA (US)

(72) Inventors: David G. Lawrence, Santa Clara, CA (US); Tim Flynn, New York, NY (US); Jeremy Sommer, Mountain View, CA (US); Gregory M. Gutt, Herndon, VA (US); Douglas J. Aiken, San Diego, CA (US); Trevor Landon, Vienna, VA (US); Maynard J. Porter, III, Haymarket, VA (US)

(21) Appl. No.: 18/599,022

(22) Filed: Mar. 7, 2024

(51) Int. Cl. G01S 19/41; B64G 1/10; G01S 19/07

(52) U.S. Cl. CPC G01S 19/41; G01S 19/071

(57) ABSTRACT

Disclosed are systems, apparatuses, processes, and computer-readable media for providing authentication of position, navigation, and timing (PNT) measurements and solutions via validated measurements and solutions. For example, an example of a method for a navigation device can include detecting, by the navigation device, errors in navigation measurements, navigation solutions, and/or navigation data, based on trusted navigation measurements. In one or more examples, the navigation measurements can include Doppler measurements, pseudorange measurements, range measurements, and/or time of arrival (TOA) measurements. In some examples, the navigation measurements can include unvalidated navigation measurements and/or validated navigation measurements. In one or more examples, the unvalidated navigation measurements and/or the validated navigation measurements may be based on signals received from one or more satellites, one or more aircraft, one or more unmanned aerial vehicles (UAVs), one or more pseudo-satellites, one or more aerial balloons, and/or one or more terrestrial cellular towers.

### FIELD OF THE DISCLOSURE

The present disclosure generally relates to position, navigation, and timing (PNT) measurements that are obtained from signals from PNT satellites. PNT satellites, which are often simply referred to as navigation satellites, are utilized for positioning, navigation, and/or timing solutions. In one or more examples, aspects of the present disclosure relate to providing authentication of PNT measurements and solutions via validated measurements and solutions.

### BACKGROUND OF THE DISCLOSURE

Currently, to solve a navigation solution (e.g., a PNT solution) of estimating position and/or velocity of a navigation device (e.g., a transceiver or a receiver) generally requires measurements of signals from four or more satellites of the traditional Global Navigation Satellite Systems (GNSSs), such as the Global Positioning System (GPS) and the Galileo European Global Navigation Satellite System (Galileo). Although there are only three dimensions of position, the trilateration techniques used by GNSSs for obtaining a navigation solution additionally need to solve for the clock uncertainty (e.g., timing offset) of the navigation device. This additional unknown clock uncertainty is the reason that measurements of signals from at least four satellites are required for solving a navigation solution. If two trilateration-based navigation systems are combined (e.g., to form a hybrid navigation system) without sharing a common clock or a means for synchronizing two independent clocks, a hybrid navigation solution will need to be employed that combines measurements of signals from the two systems. This hybrid navigation solution will have five unknowns (i.e. three dimensions of position with two unknown clock uncertainties) and, as such, will generally require measurements of signals from five or more satellites.

Navigation solutions (e.g., PNT solutions) are often subject to errors from insufficient measurements, sensor imperfections, and/or nefarious actors jamming and/or spoofing the traditional GNSSs. For any navigation system generating a navigation solution, an improved technique to prove that the navigation solution is trustworthy (e.g., to authenticate a navigation solution) can be beneficial.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described for navigation solutions (e.g., PNT solutions). According to at least one example, a method is provided for authentication of PNT measurements and solutions via validated measurements and solutions. In one or more examples, a method for a navigation device can include detecting, by the navigation device, errors in navigation measurements, navigation solutions, and/or navigation data, based on trusted navigation measurements.

In one or more examples, the navigation measurements can include Doppler measurements, pseudorange measurements, range measurements, and/or time of arrival (TOA) measurements. In some examples, the navigation measurements can include unvalidated navigation measurements and/or validated navigation measurements. In one or more examples, the unvalidated navigation measurements and/or the validated navigation measurements may be based on signals received from one or more satellites, one or more aircraft, one or more unmanned aerial vehicles (UAVs), one or more pseudo-satellites, one or more aerial balloons, and/or one or more terrestrial cellular towers.

In some examples, the unvalidated navigation measurements can be based on signals received from one or more satellites in a first constellation of satellites, and the validated navigation measurements can be based on signals received from one or more satellites in a second constellation of satellites. In one or more examples, the one or more satellites in the first constellation of satellites and the one or more satellites in the second constellation of satellites may be within communication range of the navigation device at a same time. In some examples, the one or more satellites in the first constellation of satellites are geosynchronous earth orbit (GEO) satellites, medium earth orbit (MEO) satellites, or low earth orbit (LEO) satellites. In one or more examples, the one or more satellites in the second constellation of satellites GEO satellites, MEO satellites, or LEO satellites. In some examples, the unvalidated navigation measurements can be based on signals received from one or more satellites within a same constellation of satellites.

In one or more examples, the method may further include detecting, by the navigation device, the errors, based on a comparison of a first estimated navigation solution for the navigation device with a second estimated navigation solution for the navigation device. In some examples, the first estimated navigation solution and the second estimated navigation solution can each include a position, timing, velocity, and/or attitude of the navigation device.

In one or more examples, the first estimated navigation solution can be based on a first set of measurements including the validated navigation measurements and the unvalidated navigation measurements. In some examples, the second estimated navigation solution can be based on a second set of measurements including the unvalidated navigation measurements. In one or more examples, the unvalidated navigation measurements may be fully determined unvalidated navigation measurements, and the validated navigation measurements may be underdetermined validated navigation measurements.

In some examples, the unvalidated navigation measurements and the validated navigation measurements may be based on signals synchronized to a same clock.

In one or more examples, the unvalidated navigation measurements may be based on signals synchronized to a first clock, and the validated navigation measurements may be based on signals synchronized to a second clock. In some examples, the method can further include determining, by the navigation device, timing of the first clock based on the unvalidated navigation measurements.

In some examples, the validated navigation measurements may be fully determined validated navigation measurements with a high dilution of precision (DOP). In one or more examples, the unvalidated navigation measurements and the validated navigation measurements may be based on signals synchronized to a same clock.

In one or more examples, the unvalidated navigation measurements may be underdetermined unvalidated navigation measurements, and the validated navigation measurements may be underdetermined validated navigation measurements. In some examples, the unvalidated navigation measurements and the validated navigation measurements may be based on signals synchronized to a same clock.

In some examples, a first portion of the navigation measurements may be based on signals synchronized to a first clock, and a second portion of the navigation measurements may be based on signals synchronized to a second clock. In one or more examples, the method may further include comparing, by the navigation device, the first portion of the navigation measurements that are based on the signals synchronized to the first clock with the second portion of the navigation measurements that are based on the signals synchronized to the second clock to determine a consistency with a known relative stability of the first clock and the second clock relative to each other. In some examples, the method can further include comparing, by the navigation device, the first portion of the navigation measurements that are based on the signals synchronized to the first clock with the second portion of the navigation measurements that are based on the signals synchronized to the second clock to determine a consistency with a known receiver acceleration based on a motion sensor.

In one or more examples, the trusted navigation measurements can include at least one of validated navigation measurements or local navigation measurements. In some examples, the local navigation measurements can include inertial measurements and/or barometric pressure measurements. In one or more examples, the navigation solutions can include unvalidated navigation solutions and/or validated navigation solutions. In some examples, the navigation solutions can include position, velocity, and/or attitude of the navigation device. In one or more examples, the navigation data can include unvalidated navigation data and/or validated navigation data. In some examples, the navigation data can include satellite ephemeris data, satellite orbit data, and/or satellite clock data.

In some examples, the errors may indicate a spoofable subspace. In some examples, the spoofable subspace is a line or a surface.

In one or more examples, a system for navigation can include a navigation device configured to detect errors in navigation measurements, navigation solutions, and/or navigation data, based on trusted navigation measurements. In some examples, the navigation measurements can include unvalidated navigation measurements and/or validated navigation measurements. In one or more examples, the navigation device may be further configured to detect the errors, based on a comparison of a first estimated navigation solution for the navigation device with a second estimated navigation solution for the navigation device. In some examples, the first estimated navigation solution and the second estimated navigation solution each comprise a position, timing, velocity, and/or attitude of the navigation device. In one or more examples, the first estimated navigation solution may be based on a first set of measurements including the validated navigation measurements and the unvalidated navigation measurements. In some examples, the second estimated navigation solution may be based on a second set of measurements including the unvalidated navigation measurements.

Aspects generally include a method, apparatus, system, computer program product, non-transitory computer-readable medium, user device, user equipment, wireless communication device, and/or processing system as substantially described with reference to and as illustrated by the drawings and specification.

In some aspects, each of the apparatuses described above is, can be part of, or can include a mobile device, a smart or connected device, a camera system, and/or an extended reality (XR) device (e.g., a virtual reality (VR) device, an augmented reality (AR) device, or a mixed reality (MR) device). In some examples, the apparatuses can include or be part of a vehicle, a mobile device (e.g., a mobile telephone or so-called “smart phone” or other mobile device), a wearable device, a personal computer, a laptop computer, a tablet computer, a server computer, a robotics device or system, an aviation system, or other device. In some aspects, the apparatus includes an image sensor (e.g., a camera) or multiple image sensors (e.g., multiple cameras) for capturing one or more images. In some aspects, the apparatus includes one or more displays for displaying one or more images, notifications, and/or other displayable data. In some aspects, the apparatus includes one or more speakers, one or more light-emitting devices, and/or one or more microphones. In some aspects, the apparatuses described above can include one or more sensors. In some cases, the one or more sensors can be used for determining a location of the apparatuses, a state of the apparatuses (e.g., a tracking state, an operating state, a temperature, a humidity level, and/or other state), and/or for other purposes.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and embodiments, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof.

FIG. 1 is a diagram illustrating an example of a system for providing authentication of PNT measurements and solutions via validated measurements and solutions, where the system includes navigation devices with different clocks, in accordance with some aspects of the present disclosure.

FIG. 2 is a diagram illustrating an example of a system for providing authentication of PNT measurements and solutions via validated measurements and solutions, where the system includes navigation devices with a common clock, in accordance with some aspects of the present disclosure.

FIG. 3 is a diagram illustrating an example of a validated range measurement of a signal from a satellite projected onto Earth, in accordance with some aspects of the present disclosure.

FIG. 4 shows a diagram illustrating details of the diagram of FIG. 3, in accordance with some aspects of the present disclosure.

FIG. 5 is a flow chart illustrating an example of a process for providing authentication of PNT measurements and solutions via validated measurements and solutions, in accordance with some aspects of the present disclosure.

FIG. 6 is a block diagram illustrating an example of a computing system, which may be employed by the disclosed systems and techniques for providing authentication of PNT measurements and solutions via validated measurements and solutions, in accordance with some aspects of the present disclosure.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

As previously mentioned, to solve a navigation solution (e.g., a PNT solution) of estimating position and/or velocity of a navigation device (e.g., a transceiver or a receiver, such as user equipment (UE)) generally requires measurements of signals from four or more satellites of the traditional GNSSs, such as GPS and Galileo. Although there are only three dimensions of position, the trilateration techniques used by GNSSs for obtaining a navigation solution additionally need to solve for the clock uncertainty (e.g., timing offset) of the navigation device. This additional unknown clock uncertainty is the reason that measurements of signals from at least four satellites are needed for solving a navigation solution. If two trilateration-based navigation systems are combined (e.g., forming a hybrid navigation system) without sharing a common clock or a means for synchronizing two independent clocks, a hybrid navigation solution will be needed that combines measurements of signals from the two systems. This hybrid navigation solution will have five unknowns (i.e. three dimensions of position with two unknown clock uncertainties) and, as such, will generally require measurements of signals from five or more satellites.

In some cases, navigation signals may include validation features, which can be used to prove that the signals were broadcast from an authentic system provider (e.g., from an authentic GNSS satellite). There can be cases where a subset of measurements of signals from a satellite is validated (e.g., includes validated components). For example, measurements of signals from a single satellite can include both validated and unvalidated components. For example, a time division multiple access (TDMA) broadcast may have validation features in some time slots and not in others. For another example, a code division multiple access (CDMA) broadcast may have validation data in some data subframes and not others, or with one CDMA code and not another.

In some cases, a navigation device may have received signals with validation features from one satellite and received signals without validation features from another satellite. It should be noted that not having tracked (received) validation signals from a satellite by a navigation device does not necessarily mean that the satellite is not broadcasting any validation signals. The validation signals may have simply been broadcasted by the satellite, but not tracked (received) by the navigation device. For example, the navigation device may not have tracked (received) the validation signals because of interference, attenuation, timing (e.g., the time of the broadcast of the signals was not within the time the navigation device was scanning for (e.g., tuned to receive) the signals), or other reasons. It may be that one satellite from one navigation system (e.g., a GPS satellite) broadcasts signals with validation features, and another satellite from another navigation system (e.g., a Galileo satellite) does not. It may also be that satellites from two different navigation systems (e.g., a GPS satellite(s) and a Galileo satellite(s)) both broadcast signals with validation features. A navigation device may need to have the additional integrity against spoofing and, as such, the navigation device can validate both sets of the signals (e.g., to guard against a spoofing attack, where one of the validation signals has been compromised).

In some scenarios, a navigation device may have tracked (received) signals from fewer than the required number of satellites with validated measurements. For a navigation device with a single clock or two synchronized clocks, the required number of satellites to use for a navigation solution is typically at least four satellites. For a navigation device (or two loosely integrated navigation devices) with two unsynchronized clocks, the required number of satellites to use for a navigation solution is typically at least five satellites, unless four measurements are being obtained using only one of the two clocks. In those cases, there is an underdetermined number of (e.g., not fully determined) validated measurements and, as such, a full navigation solution cannot be performed using only validated data. A set of measurements can be considered underdetermined if the dilution of precision (DOP) of those measurements is unacceptably high.

Navigation solutions (e.g., PNT solutions) are often subject to errors from insufficient measurements, sensor imperfections, and/or nefarious actors jamming and/or spoofing the traditional GNSSs. For any navigation system generating a navigation solution, an improved technique to prove that the navigation solution is trustworthy (e.g., to authenticate a navigation solution) can be useful.

In one or more aspects of the present disclosure, systems, apparatuses, methods (also referred to as processes), and computer-readable media (collectively referred to herein as “systems and techniques”) are described herein that provide solutions for providing authentication of PNT measurements and solutions via validated measurements and solutions. In one or more aspects, the systems and techniques use a combination of validated measurements and unvalidated measurements to determine a trustworthy navigation solution (e.g., which can be difficult to spoof, even when not having any fully determined validated measurements).

In one or more aspects, the systems and techniques can consider other measurements and constraints to determine whether to trust a navigation solution. For example, inertial measurements obtained by an inertial measurement unit (IMU), associated with the navigation device, can provide information about platform dynamics for a dynamic system (e.g., providing information about the dynamics of the navigation device). For another example, barometric pressure measurements obtained by a barometric altimeter, associated with the navigation device, can constrain the altitude of a navigation solution.

In one or more examples, the systems and techniques can employ a clock model to determine whether to trust a navigation solution. For examples, a clock model can be employed to perform a consistency check on the time history of clock solutions or on the instantaneous clock rate solution. For example, if a clock is known to have a stability of 1 part per billion (ppb) and a navigation solution determines that the clock frequency is 20 ppb, the navigation solution is inconsistent with the known clock performance of the clock and, as such, the navigation solution is untrustworthy. Similarly, if navigation measurements and/or solutions derived from two different clocks indicate that the relative clock-to-clock stability exceeds the two clocks' known actual relative stabilities, the navigation measurements and/or solutions are inconsistent with the known clock performance of the two clocks and, as such, the navigation measurements and/or solutions are untrustworthy.

In some examples, the systems and techniques can consider the motion of the navigation device to determine whether to trust a navigation solution. For example, in cases where a navigation device is known to be experiencing acceleration (e.g., is not stationary), the effects of such acceleration on the navigation measurements derived from different clocks may be compared for consistency. For another example, in other cases, it may be known that a navigation device is stationary. This constraint (e.g., stationary constraint) on the navigation device can significantly reduce the number of unknowns over time, because the navigation device clock(s) should only change with time (not motion) in these cases.

In one or more examples, the systems and techniques can employ several different scenarios using a combination of validated and unvalidated measurements, or measurements validated from different sources, to determine whether to trust a navigation solution. For each of these scenarios, methods are disclosed that leverage the validated measurements to determine a navigation solution and perform an integrity check on the navigation solution itself.

Additional aspects of the present disclosure are described in more detail below.

As used herein, the terms “user equipment” (UE) and “navigation device” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network, and used to receive signals (e.g., navigation signals or PNT signals) from a satellite (e.g., a GNSS satellite) and, optionally, transmit signals to a satellite (e.g., a GNSS satellite). A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network (e.g., which may include a server, such as a navigation server) via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

In some implementations that support positioning of UEs, a satellite (e.g., a GNSS satellite) may not support wireless access by UEs (e.g., may not support data, voice, and/or signaling connections for UEs), but may instead transmit navigation signals (e.g., PNT signals) to UEs to be measured by the UEs for positioning purposes.

An RF signal includes an electromagnetic wave of a given frequency that transports information through the space between a transmitter and a receiver. As used herein, a transmitter (e.g., a satellite) may transmit a single “RF signal” or multiple “RF signals” to a receiver (e.g., a navigation device). However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

In one or more aspects, the systems and techniques can use various combinations of validated PNT measurements and/or solutions, which can facilitate the authentication (e.g., validation) of other (e.g., unvalidated) PNT measurements and solutions.

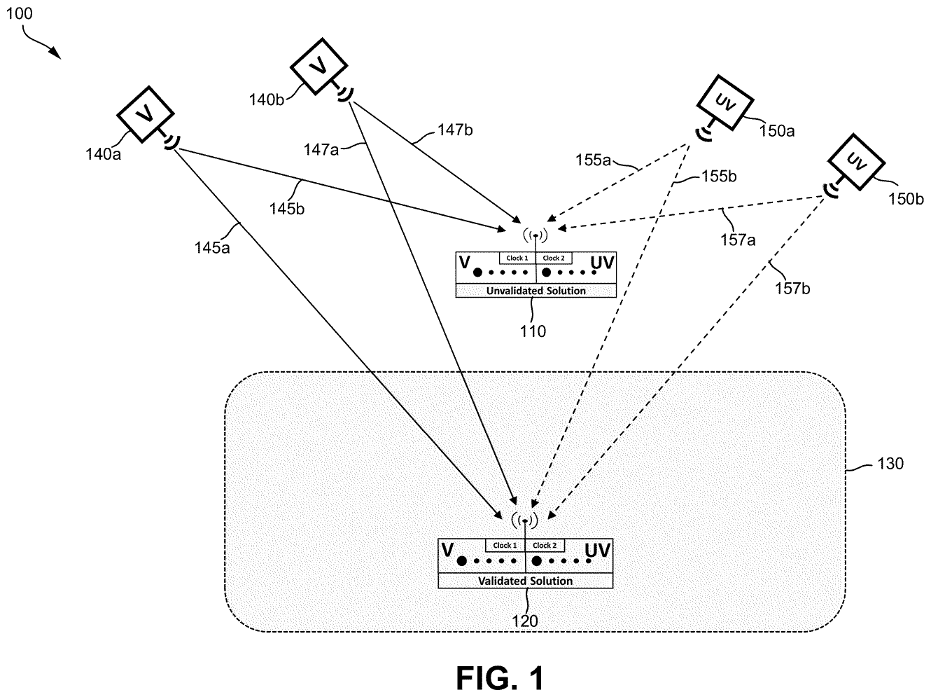

In one or more aspects, the systems and techniques may employ navigation devices (e.g., transceivers or receivers, such as in the form of UEs) without a common clock (e.g., as shown in the system 100 of FIG. 1) and can use undetermined validated measurements (e.g., from validated signals) to authenticate a navigation solution (e.g., to determine whether a navigation solution is trustworthy or not, based on the determination of errors within the navigation solution) (e.g., refer to the pseudocode below for example 2). FIG. 1 shows a system 100 including navigation devices 110, 120. The navigation devices 110, 120 may each be a transceiver or a receiver, which may be in the form of a UE, such as a smart phone. Each of the navigation devices 110, 120 do not have a common clock, and are shown to include two clocks (e.g., clock 1 and clock 2). In one or more examples, the two clocks operate separately and independently of one another and, as such, the two clocks may have different clock drift rates. In FIG. 1, the navigation device 120 is shown to be located within a validated measurement region 130. The navigation device 110 is not located within a validated measurement region. In one or more examples, the system 100 may include more or less number of navigation devices 110, 120, than as shown in FIG. 1.

The system 100 of FIG. 1 is shown to also include multiple satellites 140a, 140b, 150a, 150b. The satellites 140a, 140b, 150a, 150b are located within communication range of the navigation devices 110, 120 such that the navigation devices 110, 120 can receive signals (e.g., navigation signals) transmitted from the satellites 140a, 140b, 150a, 150b. The satellites 140a, 140b are validated (V) sources that transmit validated signals 145a, 145b, 147a, 147b, and the satellites 150a, 150b are unvalidated (UV) sources that transmit unvalidated signals 155a, 155b, 157a, 157b. The satellites 140a, 140b, 150a, 150b may be within one or more satellite constellations (e.g., GNSS constellations). The satellites 140a, 140b, 150a, 150b may be geosynchronous earth orbit (GEO) satellites, medium earth orbit (MEO) satellites, and/or low earth orbit (LEO) satellites. The satellites 140a, 140b (e.g., validated sources) and the satellites 150a, 150b (e.g., unvalidated sources) may be in the same satellite constellation or in different satellite constellations.

During operation of the system 100, the satellites 140a, 140b, being validated sources, can transmit validated signals 145a, 145b, 147a, 147b to the navigation devices 110, 120. The navigation devices 110, 120 can receive the validated signals 145a, 145b, 147a, 147b using a first clock (e.g., clock 1), and can obtain measurements (e.g., validated measurements) of the validated signals 145a, 145b, 147a, 147b. In one or more examples, validated measurements are measurements that have been verified to be true.

The satellites 150a, 150b, being unvalidated sources, can transmit unvalidated signals 155a, 155b, 157a, 157b to the navigation devices 110, 120. The navigation devices 110, 120 can receive the unvalidated signals 155a, 155b, 157a, 157b using a second clock (e.g., clock 2), and can obtain measurements (e.g., unvalidated measurements) of the unvalidated signals 155a, 155b, 157a, 157b. In one or more examples, unvalidated measurements are measurements that have not been verified to be true (e.g., valid), and may, for example, be spoofed.

In one or more examples, the unvalidated navigation measurements and/or the validated navigation measurements may be based on signals received from sources other than satellites. In some examples, the unvalidated navigation measurements and/or the validated navigation measurements may be based on signals received from sources in the form of aircraft, UAVs, pseudo-satellites, aerial balloons, and/or terrestrial emitters (e.g., terrestrial cellular towers).

After the navigation devices 110, 120 have obtained the validated measurements and unvalidated measurements, each of the navigation devices 110, 120 can process the measurements to determine a navigation solution for themselves. For example, the navigation device 110 can process the measurements to determine a navigation solution (e.g., a positioning, navigation, and/or timing solution) for itself, the navigation device 110. In FIG. 1, since the navigation device 120 is located within a validated measurement region 130, the navigation solution determined by the navigation device 120 may be a validated navigation solution. In one or more examples, a validated navigation solution is a navigation solution with a verified position, velocity, and/or time. Conversely, since the navigation device 110 is not located within a validated measurement region, the navigation solution determined by the navigation device 110 may be an unvalidated navigation solution. In one or more examples, an unvalidated navigation solution is a navigation solution without a verified position, velocity, and/or time.

In one or more examples, one or both of the navigation devices 110, 120 can perform the processing of the measurements to determine a navigation solution. In some examples, other navigation devices (e.g., a server including one or more processors, such as a navigation server) located remote from the navigation devices 110, 120 can perform the processing of the measurements to determine a navigation solution for one or both of the navigation devices 110, 120. For these examples, the navigation devices 110, 120 can transmit their obtained measurements (e.g., validated and unvalidated measurements) via wire and/or wirelessly (e.g., over the Internet) to the navigation device (e.g., server) to perform the processing.

In one or more aspects, if a navigation device (e.g., transceiver or receiver, such as a UE, or a server, such as a navigation server) obtains multiple unvalidated measurements (e.g., obtained from multiple unvalidated signals), but only obtains one validated measurement (e.g., obtained from one validated signal), the navigation device can determine which clock was used to make that validated measurement from the position (e.g., of the navigation device in the form of a transceiver or a receiver, such as a UE) derived from the unvalidated measurements. The navigation device can then check (confirm) that the clock solution behavior is consistent with the known performance and measurement error statistics for that clock to determine whether the navigation solution is trustworthy (e.g., to determine whether the navigation solution is a trusted navigation solution).

In one or more examples, the clock state can be found by:

$$clock = \frac{pseudorange - range}{c} + corrections\_a \qquad [ Equation 1 ]$$

where the “range” is the range from the navigation device to the satellite (e.g., which can be calculated from the position derived from the unvalidated measurements), the “pseudorange” is the received time of the validated signal in the navigation device (e.g., transceiver or receiver) time minus the known absolute transmission time of the validated signal expressed in distance units by multiplying by the speed of light, “c” is the speed of light, and “corrections_a” are adjustments to the solution to compensate for effects (e.g., such as atmospheric delay, relativity, etc.).

In one or more examples, the clock rate state can be found by:

$$clock rate = \frac{- Doppler - {range}_{rate}}{c} + {corrections}_{b} \qquad [ Equation 2 ]$$

where the “clock rate” is a dimensionless clock drift rate (e.g., seconds of drift per second), “Doppler” is the measured frequency of the validated signal relative to the nominal frequency of the validated signal (e.g., converted to meters per second by multiplying its value in cycles per second by the wavelength of the validated signal), and “corrections_b” are adjustments to the clock rate solution to model various effects on the signal (e.g., such as atmospheric delay, relativity, etc.). In one or more examples, the navigation device (e.g., a transceiver, receiver, or server) can check (confirm) that the clock solution behavior is consistent with the known performance and measurement error statistics for that clock by comparing the calculated clock state to the calculated clock rate state.

In some examples, alternatively, a hybrid estimator (e.g., a Kalman filter) may be employed and can use both validated measurements (e.g., from validated signals) and unvalidated measurements (e.g., from unvalidated signals) to authenticate a navigation solution (e.g., to determine whether a navigation solution is trustworthy or not, based on the determination of errors within the navigation solution). In one or more examples, the hybrid estimator can include two clocks (e.g., clock states) and two clock process models that are consistent with the each of the two clocks. For a dynamic platform (e.g., a navigation device, such as a transceiver or receiver, in motion), the estimator states (e.g., estimations of the clock states) may include the two clock biases, two clock rates, three position states, and three velocity states for the navigation device. In one or more examples, measurement updates to the estimator states can be applied (e.g., by the navigation device) to properly reflect which clock (of the two clocks) was used to obtain each of the measurements. In some examples, measurement residuals may be calculated (e.g., by the navigation device, such as a transceiver, receiver, or server) by subtracting expected measurements from the actual measurements. The expected measurements may be a function of the estimator state, including the clock and clock rate states for each of the clocks. In one or more examples, the measurements can include pseudorange measurements and/or Doppler measurements. In one or more examples, the navigation device (e.g., transceiver, receiver, or server) may apply additional measurements (e.g., IMU data, such as inertial measurements, barometric altimeter data, such as barometric pressure measurements, etc.) obtained by the navigation device (e.g., transceiver or receiver) as measurement updates to the estimator state(s).

In one or more examples, if the navigation device (e.g., transceiver or receiver, such as a UE, or a server, such as a navigation server) receives more than one validated measurement, but receives less than a fully determined set of validated measurements, the navigation device can perform additional integrity checks (confirmations) that rely less on an accurate clock model. The term “fully determined” can mean that there are an equal or greater number of measurements than the number of unknown variables. In one or more examples, the navigation device can use a position solution determined from the unvalidated measurements to find multiple estimates for the clock used to make the validated measurements (e.g., one estimate per validated measurement). The navigation device can then check (confirm) that those estimates are consistent with each other to the level expected based on the measurement accuracy statistics (e.g., the difference between the estimates is lower than a predetermined threshold level). Of course, even when using multiple validated measurements, the clock solution can still be checked (confirmed), by the navigation device, against a model for consistency, as could be done when using only a single validated measurement.

In some examples, alternatively, a navigation device (e.g., transceiver or receiver, such as a UE, or a server, such as a navigation server) can use a combination of unvalidated and validated measurements to find a position, velocity, two clocks, and a residual. The navigation device can check (confirm) that the clock change is realistic and that the residual is lower than a predetermined threshold level. A residual will be available because these examples involve at least a fully determined set of measurements (e.g., such that there are at least as many measurements as unknowns, only considering the unvalidated measurements) and at least one more measurement than the additional single unknown (second clock) introduced when using the validated measurements because there is more than one validated measurement. When there are more measurements than unknowns, a residual can be calculated.

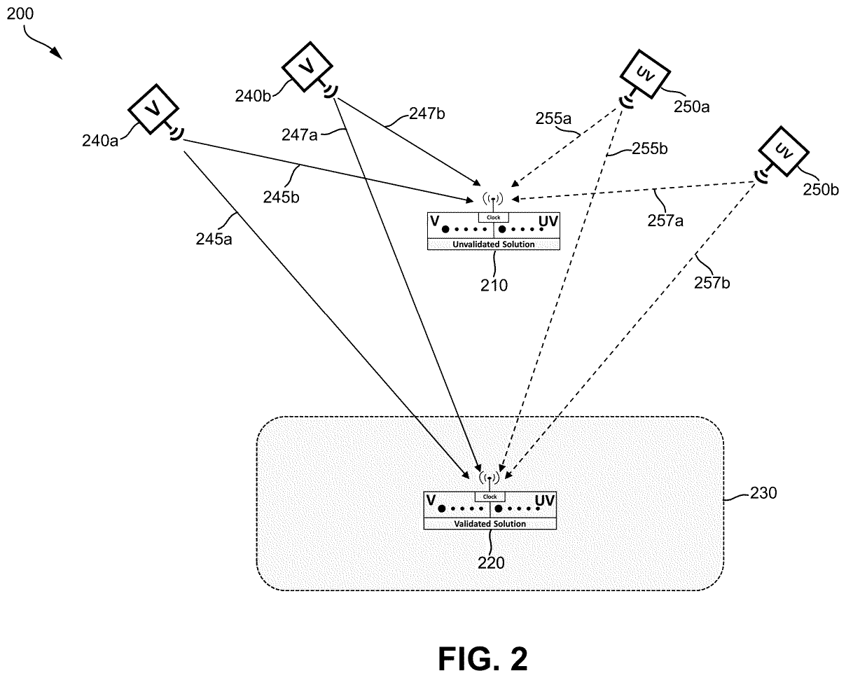

In one or more aspects, the systems and techniques may employ navigation devices (e.g., transceivers or receivers, such as in the form of UEs) with a common clock (e.g., as shown in the system 200 of FIG. 2) and can use validated measurements (e.g., from validated signals) to authenticate a navigation solution (e.g., to determine whether a navigation solution is trustworthy or not, based on the determination of errors within the navigation solution) (e.g., refer to the pseudocode below for examples 1, 3, and 4). FIG. 2 shows a system 200 including navigation devices 210, 220. The navigation devices 210, 220 may each be a transceiver or a receiver, which may be in the form of a UE, such as a smart phone. Each of the navigation devices 210, 220 has a common clock, and is shown to include one clock. In FIG. 2, the navigation device 220 is shown to be located within a validated measurement region 230, and the navigation device 210 is shown to not be located within a validated measurement region. In one or more examples, the system 200 may include more or less number of navigation devices 210, 220, than as shown in FIG. 2.

The system 200 of FIG. 2 is also shown to include multiple satellites 240a, 240b, 250a, 250b. The satellites 240a, 240b, 250a, 250b are located within communication range of the navigation devices 210, 220 so that the navigation devices 210, 220 can receive signals (e.g., navigation signals) transmitted from the satellites 240a, 240b, 250a, 250b. The satellites 240a, 240b are validated (V) sources that transmit validated signals 245a, 245b, 247a, 247b. The satellites 250a, 250b are unvalidated (UV) sources that transmit unvalidated signals 255a, 255b, 257a, 257b. The satellites 240a, 240b, 250a, 250b can be within one or more satellite constellations (e.g., GNSS constellations). The satellites 240a, 240b, 250a, 250b can be GEO satellites, MEO satellites, and/or LEO satellites. The satellites 240a, 240b (e.g., validated sources) and the satellites 250a, 250b (e.g., unvalidated sources) may be in the same satellite constellation or in different satellite constellations.

During operation of the system 200 of FIG. 2, the satellites 240a, 240b, being validated sources, can transmit validated signals 245a, 245b, 247a, 247b to the navigation devices 210, 220. The navigation devices 210, 220 can receive the validated signals 245a, 245b, 247a, 247b using their clock, and can obtain measurements (e.g., validated measurements) of the validated signals 245a, 245b, 247a, 247b. The satellites 250a, 250b, being unvalidated sources, can transmit unvalidated signals 255a, 255b, 257a, 257b to the navigation devices 210, 220. The navigation devices 210, 220 can receive the unvalidated signals 255a, 255b, 257a, 257b using their clock, and can obtain measurements (e.g., unvalidated measurements) of the unvalidated signals 255a, 255b, 257a, 257b.

After the navigation devices 210, 220 have obtained the validated measurements and unvalidated measurements, each of the navigation devices 210, 220 may process the measurements to determine a navigation solution for themselves. For example, the navigation device 210 can process the measurements to determine a navigation solution (e.g., a positioning, navigation, and/or timing solution) for itself, the navigation device 210. In FIG. 2, since the navigation device 220 is located in a validated measurement region 230, the navigation solution determined by the navigation device 220 can be a validated navigation solution. Since the navigation device 210 is not located within a validated measurement region, the navigation solution determined by the navigation device 210 can be an unvalidated navigation solution.

In one or more examples, one or both of the navigation devices 210, 220 may perform the processing of the measurements to determine a navigation solution. In some examples, other navigation devices (e.g., a server including one or more processors, such as a navigation server) located remote from the navigation devices 210, 220 can perform the processing of the measurements to determine a navigation solution for one or both of the navigation devices 210, 220. For these examples, the navigation devices 210, 220 may transmit their obtained measurements (e.g., validated and unvalidated measurements) via wire and/or wirelessly (e.g., over the Internet) to the navigation device (e.g., server) to perform the processing.

In one or more aspects, the systems and techniques may employ navigation devices (e.g., transceivers or receivers, such as in the form of UEs) with a common clock (e.g., as shown in the system 200 of FIG. 2) and can use underdetermined validated measurements (e.g., from validated signals) to authenticate a navigation solution (e.g., to determine whether a navigation solution is trustworthy or not, based on the determination of errors within the navigation solution) (e.g., refer to the pseudocode below for example 1). The term “underdetermined” can mean that there are a less number of measurements than the number of unknown variables. In one or more examples, a navigation device can use the determined position and clock estimate from unvalidated measurements to find a residual for underdetermined measurements. In some examples, a navigation device can find a three-dimensional (3D) subspace of where the position must be located, based on the validated measurements. The navigation device can check (confirm) whether the position estimate is located within or near the 3D subspace. In one or more examples, the navigation device can use a combination of unvalidated and validated measurements together to find a position, velocity, common clock, and a residual. The navigation device can check (confirm) that the clock change is realistic and that the residual is lower than a predetermined threshold level.

In one or more aspects, the systems and techniques may employ navigation devices (e.g., transceivers or receivers, such as in the form of UEs) with a common clock (e.g., as shown in the system 200 of FIG. 2) and can use underdetermined unvalidated measurements (e.g., from unvalidated signals) and underdetermined validated measurements (e.g., from validated signals) to authenticate a navigation solution (e.g., to determine whether a navigation solution is trustworthy or not, based on the determination of errors within the navigation solution) (e.g., refer to the pseudocode below for example 4). In one or more examples, the navigation device can solve for independent navigation solutions and compare them with each other.

In some examples, if the unvalidated position accuracy is expected to be better than unvalidated measurements and the independent navigation solutions are consistent with each other, the navigation device can find a weighted solution that optimizes the accuracy, while maintaining an predetermined anti-spoof protection limit. For a simple one dimensional (1D) example, the validated measurements may indicate the estimated position of the navigation device (e.g., UE) to be at x=0+/100 meters (m), and the unvalidated measurements may indicate the estimated position of the navigation device (e.g., UE) to be at 70 m+/−25 m. The anti-spoof protection limit may require that a spoofer cannot spoof the position by more than 150 m. A hybrid solution may determine the position of the navigation device (e.g., UE) to be at x=50 m. As such, the navigation device is located 150 m from the edge of the validated range measurement, but is located closer to the nominally more accurate unvalidated solution.

In one or more aspects, the systems and techniques may employ navigation devices (e.g., transceivers or receivers, such as in the form of UEs) with a common clock (e.g., as shown in the system 200 of FIG. 2) and can use underdetermined unvalidated measurements (e.g., from unvalidated signals) and underdetermined validated measurements (e.g., from validated signals) to authenticate a navigation solution (e.g., to determine whether a navigation solution is trustworthy or not, based on the determination of errors within the navigation solution) (e.g., refer to the pseudocode below for example 4). In one or more examples, if neither the unvalidated measurements nor the validated measurements by themselves can be used by the navigation device to find a navigation solution, the navigation device can still determine a navigation solution that is more difficult to spoof than a navigation solution determined by using only unvalidated measurements. There are several sub-scenarios of finding a navigation solution to consider.

In one or more examples, for a first scenario, if the combination of unvalidated measurements and validation measurements is underdetermined (e.g., two unvalidated measurements and one validated measurement obtained using a common clock), the navigation device may not determine a full navigation solution. However, for some applications, an underdetermined navigation solution including a parametric curve or a surface may still be useful. For example, a navigation device may not solve for the four unknowns of position and clock, but the navigation device may solve for a curve in space where each point on the curve corresponds to a different clock solution. If the navigation device is trying to determine whether (or not) a receiver is located at a specific location or region, knowing all possible locations where the receiver could be located can be useful. Spoofing, by a potential spoofer, the unvalidated signals to adjust the curve would be more difficult for the spoofer, than spoofing a completely unvalidated set of measurements.

In some examples, for a second scenario, if the combination of unvalidated measurements and validated measurements is fully determined without either being individually fully determined, a navigation device may use a hybrid navigation solution. If the hybrid solution has a minimum number of measurements to be fully determined (e.g., four measurements for an unconstrained 3D solution with a single clock, or five measurements for an unconstrained 3D solution with two unsynchronized clocks), a navigation device may not perform a consistency check (confirmation) on an instantaneous basis (e.g., other than checks on clock frequency consistency with a model or checks on position or velocity). However, over time, the navigation device can compare trends in the clock solution (or position solution) against models for the clock (or for the platform dynamics). It would be more difficult to spoof, by a potential spoofer, the unvalidated subset of the signals and escape detection of such consistency checks, than to spoof a similar set of unvalidated measurements.

In one or more examples, a potential spoofer may desire to move a navigation solution in a specific direction. For example, a drone could be guided off course towards a location, where it could be captured. In some examples, a hybrid solution may not be spoofable in the direction the spoofer wants to move the solution. For example, if three validated measurements are combined with one unvalidated measurement, the hybrid solution would only be spoofable in a single dimension. As the spoofer adjusted the timing of the one unvalidated measurement, the position solution would move along a line. For linearized navigation equations, that line would be straight. For full non-linear equations, the line would be curved in space. In either case, the line would generally not pass through the location that the spoofer wanted to move the solution. Furthermore, that line would move as satellites move. For example, if the validated measurements were from signals from LEO satellites, the line would move particularly fast. Even if the line aligned with the direction the spoofer wanted to move the solution at one time, the line would not be sufficiently aligned with that direction a short time later. The line would not generally be horizontal and, as such, an altimeter measurement could constrain the position along the line. In that case, the unvalidated measurements could be used to improve the accuracy of the validated measurements and altimeter solution (e.g., which may have a high level of uncertainty, depending upon the geometry of the three satellites with validated measurements) without providing the spoofer the ability to grossly and undetectably move the solution. When using only two validated satellites, the spoofable region would be a two dimensional (2D) surface, such as a plane for linearized navigation equations or a curved surface for the full non-linear model. Again, the validated region will generally not pass through the spoofer-desired location and will change as satellites move. If the surface is horizontal, an altimeter solution would again constrain the spoofable space (e.g., from a 2D surface to a 1D curve).

In some examples, for a third scenario, if the combination of validated and unvalidated measurements is overdetermined (fully determined) (e.g., two unvalidated measurements and three validated measurements with a common clock), a navigation device may calculate a solution residual. If the solution residual is greater than expected, based on the statistics of the measurement errors, a possible spoofing attack or other error may be flagged (e.g., by the navigation device). For example, it can be difficult for a potential spoofer to cause the measurement residual to be small and it can be impossible for the spoofer to spoof the two unvalidated signals in such a way to result in both a small residual and an arbitrary position solution. The low residual position solution could be constrained to a 1D curve in position (or clock space), which would be unlikely to be consistent with a realistic platform model (or realistic clock dynamics).

In one or more aspects, the systems and techniques may employ navigation devices (e.g., transceivers or receivers, such as in the form of UEs) with a common clock (e.g., as shown in the system 200 of FIG. 2) and can use underdetermined unvalidated measurements (e.g., from unvalidated signals) and fully determined validated measurements (e.g., from validated signals) to authenticate a navigation solution (e.g., to determine whether a navigation solution is trustworthy or not, based on the determination of errors within the navigation solution) (e.g., refer to the pseudocode below for example 3). In one or more examples, if a fully determined set of validated measurements is available, a navigation device can augment a navigation solution with unvalidated measurements to improve its accuracy, subject to constraints on how far the unvalidated measurements can move the navigation solution from its fully validated state. These examples are similar to the fully determined validated and fully determined unvalidated examples discussed above in the third scenario, except that there is no independent validated navigation solution for these examples. Instead, for these examples, a navigation device can compare a navigation solution derived completely from validated measurements (e.g., which may potentially have a poor or low DOP) with a hybrid solution. The navigation device can derive a trustworthy navigation solution from those two solutions by moving the validated solution towards the hybrid solution, without moving it so far as to allow a potential spoofer to move the solution by an unacceptable amount of distance.

In one or more examples, the navigation device may use the code phase of validated measurements to determine a navigation solution. In some examples, the navigation device may use the carrier phase of validated measurements (e.g., for a more precise consistency check) to determine a navigation solution. In one or more examples, a high accuracy position and errors small enough to resolve cycle ambiguities.

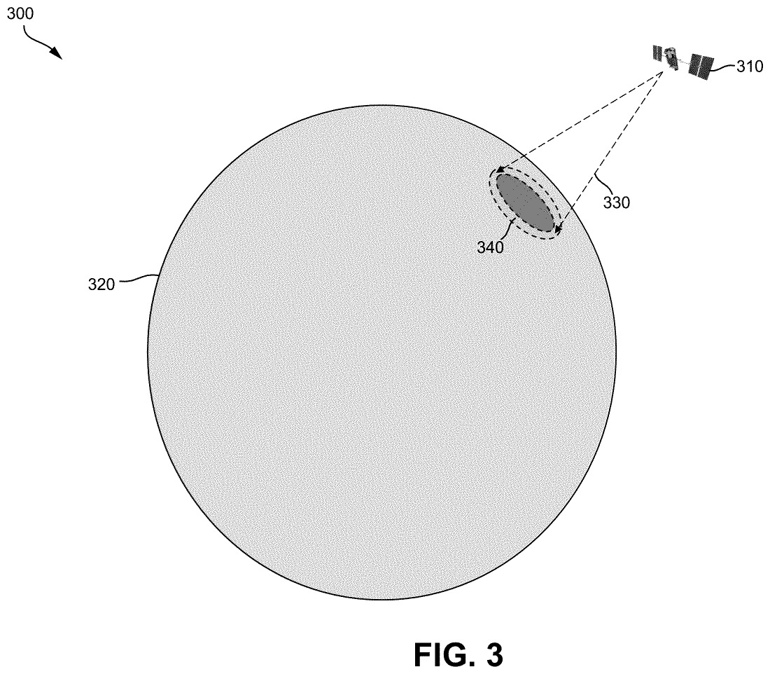

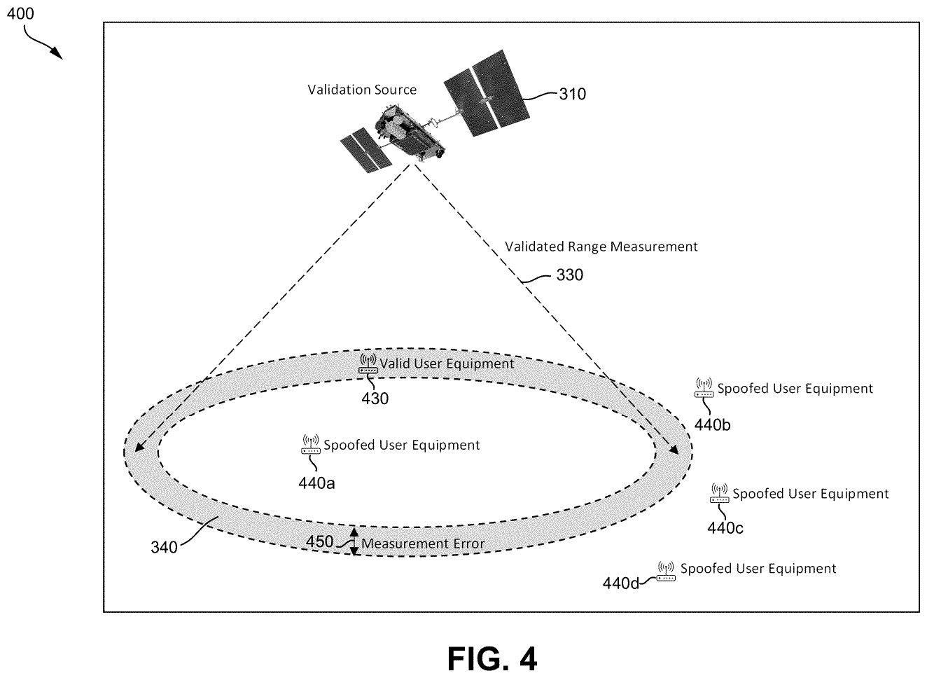

In one or more aspects, a navigation device can validate a position estimate of a navigation solution by using a validated pseudorange measurement. FIG. 3 shows an example 300 of a validated range measurement 330 of a signal from a satellite (e.g., a validated source 310) projected onto Earth 320. FIG. 4 shows an example 400 of details of the diagram of FIG. 1. In FIGS. 3 and 4, a validated source 310 (e.g., a GNSS satellite, such as an Iridium satellite) and a validation range measurement 330 (e.g., from a satellite, time, and location (STL) waveform) are shown. A validity region 340 is also shown in the figures. The validity region 340 is a region where a navigation solution (e.g., a PNT solution, such as an estimated position for a navigation device) would be considered authentic from a single validated range measurement 330. For example, in FIG. 4, a navigation device 430 (e.g., UE) and spoofed navigation devices 440a, 440b, 440c, 440d are shown. In one or more examples, the navigation device 430 can be determined to be an authentic (valid) navigation device because the authentic navigation device 430 is located within the validity region 340. The navigation device 430 (e.g., UE) may have a navigation solution (e.g., a PNT solution) that falls within the validated range measurement's validity region 340 (e.g., spanning the measurement error 450), while the spoofed navigation devices 440a, 440b, 440c, 440d are all located outside of the validity region 340 (e.g., a spoofable subspace). In one or more examples, a spoofable subspace (e.g., which may be in the form of a line or a surface) is a region (e.g., outside of the validity region 340) where a spoofed PNT solution (e.g., a spoofed navigation device) could be moved without effecting residual errors. Since the navigation device 430 is located within the validity region 340, that navigation solution (e.g., PNT solution) of the navigation device 340 can be successfully authenticated (validated).

In one or more aspects, the systems and techniques may employ code to for performing the disclosed methods. Examples of pseudocode that the systems and techniques may employ are shown below.

% Example: initialize a seven satellite linearized observation (“H”) matrix for a common clock.
H7=[0.905419 −0.268571 0.328763 1
0.450195 −0.209576 0.867988 1
−0.686536 0.485565 0.541198 1
0.636140 0.515823 0.573806 1
−0.641169 0.602268 0.475580 1
−0.505307 0.062625 0.860664 1
0.090981 −0.741525 0.664728 1];
% Let the true position/clock value be equal to zero.
xtrue=zeros(4,1);
% Let the measurement errors are normally distributed with a standard deviation of 10 meters.

$$meas = randn ( 7.1 ) * 10 ;$$

% Example 1: fully determined unvalidated measurements (four satellites), underdetermined validated measurements (three satellites), with a common clock
% H matrix for unvalidated measurements
Hu=H7(1:4, :);
Hv=H7(5:7, :);
% Solve for position and a residual using all measurements.

$$xest 1 = [ Hu ; Hv ] ∖ meas$$

$$residual = meas - [ Hu ; Hv ] * xest 1$$

% Alternatively, solve for position using the unvalidated measurements.

$$xest = Hu ∖ mea s ( 1 : 4 ) ;$$

% Then, perform a consistency by defining another residual.

$$residual = meas ( 5 : 7 ) - Hv * xest$$

% Both residual 1 and residual 2 will become large in magnitude if a spoofer attempts to arbitrarily move the solution.
% The only direction a spoofer could move the solution while keeping the residual small is in the direction parallel to the % null space of Hv
xspoof=null(Hv);
% This spoofable subspace can be provided to the consumer of the position solution which can decide if it is acceptable
% for and application
% For this example, that direction is [7.8016e-01; 4.8124e-01; 3.9915e-01; 2.0549e-02]
% To spoof the position solution east by 78 m, the solution would have to be spoofed by 48 m north and 40 m up.
% This makes it difficult to remain undetected and impossible to arbitrarily change the position solution.

% Example 2: same geometry as Example 1, but use independent clocks for the validated and unvalidated measurements.
Hu=[0.905419 −0.268571 0.328763 1 0
0.450195 −0.209576 0.867988 1 0
0.686536 0.485565 0.541198 1 0
0.636140 0.515823 0.573806 1 0]
Hv=[−0.641169 0.602268 0.475580 0 1
−0.505307 0.062625 0.860664 0 1
0.090981 −0.741525 0.664728 0 1];

$$xest 1 = [ Hu ; Hv ] ∖ meas$$

$$residual = meas - [ Hu ; Hv ] * xest 1$$

% Again, solve for the position and first clock using only the unvalidated measurements.

$$xest = Hu ∖ meas ( 1 : 4 ) ;$$

% Since the second clock was not solved for, it must be removed from the validated equations.
% That can be accomplished by subtracting one measurement from the remaining measurements, which can be done by pre-multiplying by:

$$L = [ - 110 ; - 101 ] ;$$

$$residual = L * meas ( 5 : 7 ) - L * Hv * [ xest ; 0 ]$$

% Example 3, fully determined validated measurements with high DOP and some additional unvalidated measurements, using a common clock.
Hv=H7([2; 3; 5; 7], :); % Higher PDOP subset of H7
Hu=H7([1; 4; 6], :); % the remaining rows
% A solution can be found using only the validated measurements

$$xest = Hv ∖ meas ( [ 2357 ] ) ;$$

% That measurement, although not spoofable may have high errors due to geometry deficiency.
% A combined estimate can be found that has higher accuracy in the absence of spoofing while maintaining spoof resistance.
% A spoofer may be able to pull the measurement off by a bounded amount in the direction(s) of poor geometry for the validated measurements.

$$xest = [ Hv ; Hu ] ∖ meas ( [ 2357146 ] ) ;$$

Hv=H7([2; 3; 5; 7], :); % Higher PDOP subset of H7
Hu=H7([1; 4; 6], :); % the remaining rows
% A residual can be found as before

$$residual = meas ( [ 2357146 ] ) - [ Hv ; Hu ] * xest$$

% Example 4, underdetermined validated, underdetermined unvalidated, using common clock, and fully determined overall.
Hu=H7(1:3, :); % 3 unvalidated measurements
Hv=H7(4:6, :); % 3 validated measurements

$$xest = [ Hu ; Hv ] ∖ meas ( 1 : 6 )$$

$$residual = meas ( 1 : 6 ) - [ Hu ; Hv ] * xest$$

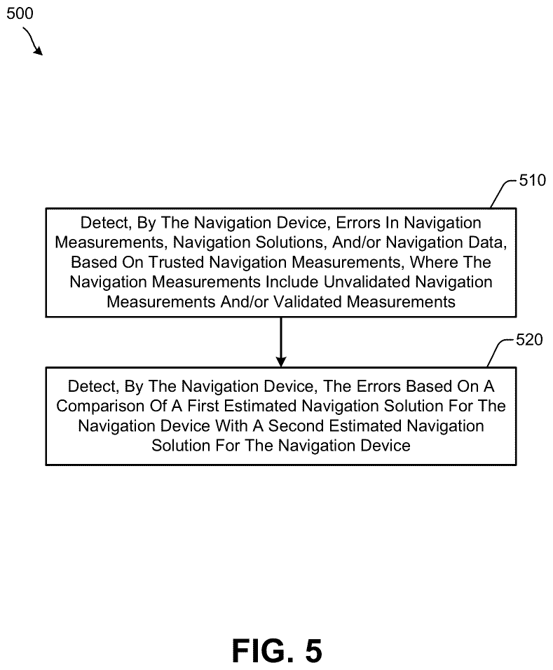

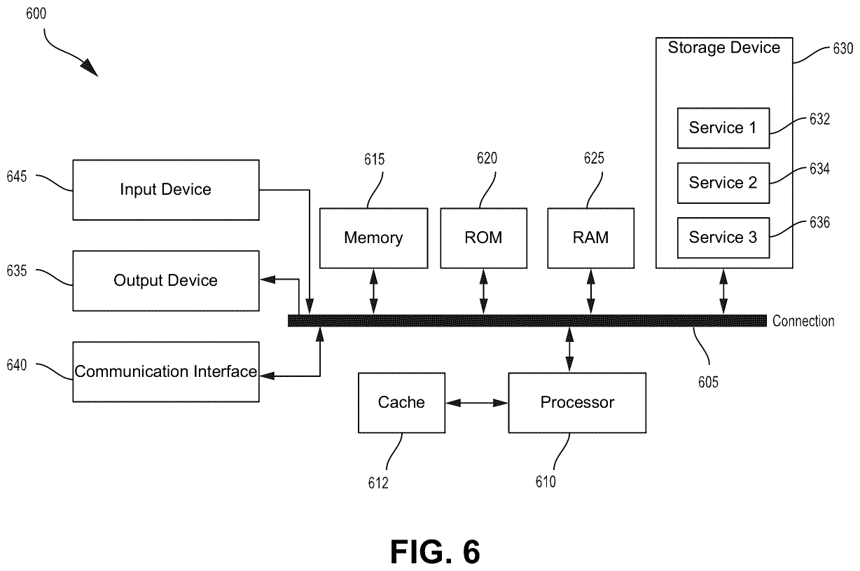

FIG. 5 is a flow chart illustrating an example of a process 500 for wireless communications using methods for providing authentication of PNT measurements and solutions via validated measurements and solutions. The process 500 can be performed by a navigation device (e.g., transceiver or a receiver, which may be in the form of a UE, such as navigation device 110, 120 of FIG. 1 or navigation device 210, 220 of FIG. 2, or a server, such as a navigation server) or a component or system (e.g., a chipset) of the navigation device. The UE may be a mobile device (e.g., a mobile phone, such as a smart phone), a vehicle, a wearable device (e.g., a network-connected watch or other wearable device), an extended reality (XR) device (e.g., a virtual reality (VR) or augmented reality (AR) headset or glasses), or other type of UE. The operations of the process 500 may be implemented as software components that are executed and run on one or more processors (e.g., processor 610 of FIG. 6 or other processor(s)). Further, the transmission and/or reception of signals by the navigation device in the process 500 may be enabled, for example, by one or more antennas and/or one or more transceivers (e.g., wireless transceiver(s)).

At block 510, the navigation device (or component thereof) may detect errors in navigation measurements, navigation solutions, and/or navigation data, based on trusted navigation measurements. In one or more examples, the navigation measurements can include Doppler measurements, pseudorange measurements, range measurements, and/or time of arrival (TOA) measurements. At block 520, the navigation device can detect the errors based on a comparison of a first estimated navigation solution for the navigation device with a second estimated navigation solution for the navigation device.

The navigation device (e.g., a transceiver or receiver, such as a UE, or a server, such as a navigation server) may include various components, such as one or more input devices, one or more output devices, one or more processors, one or more microprocessors, one or more microcomputers, one or more cameras, one or more sensors, one or more receivers, transmitters, and/or transceivers, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the navigation device, configured to perform the process 500 of FIG. 5, can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 500 of FIG. 5 is one example of a process that is illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 500 of FIG. 5 and/or any other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 6 is a block diagram illustrating an example of a computing system 600, which may be employed by the disclosed systems and techniques for providing authentication of PNT measurements and solutions via validated measurements and solutions. In particular, FIG. 6 illustrates an example of computing system 600, which can be, for example, any computing device making up internal computing system, a remote computing system, a camera, or any component thereof in which the components of the system are in communication with each other using connection 605. Connection 605 can be a physical connection using a bus, or a direct connection into processor 610, such as in a chipset architecture. Connection 605 can also be a virtual connection, networked connection, or logical connection.

In some aspects, computing system 600 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 600 includes at least one processing unit (CPU or processor) 610 and connection 605 that communicatively couples various system components including system memory 615, such as read-only memory (ROM) 620 and random access memory (RAM) 625 to processor 610. Computing system 600 can include a cache 612 of high-speed memory connected directly with, in close proximity to, or integrated as part of processor 610.

Processor 610 can include any general purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms. In some instances, multimodal systems can enable a user to provide multiple types of input/output to communicate with computing system 600.

Computing system 600 can include communications interface 640, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 640 may also include one or more range sensors (e.g., LIDAR sensors, laser range finders, RF radars, ultrasonic sensors, and infrared (IR) sensors) configured to collect data and provide measurements to processor 610, whereby processor 610 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 630 can include software services, servers, services, etc., that when the code that defines such software is executed by the processor 610, it causes the system to perform a function. In some aspects, a hardware service that performs a particular function can include the software component stored in a computer-readable medium in connection with the necessary hardware components, such as processor 610, connection 605, output device 635, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. A method for a navigation device, the method comprising:
detecting, by the navigation device, errors in at least one of navigation measurements, navigation solutions, or navigation data, based on trusted navigation measurements.

2. The method of claim 1, wherein the navigation measurements comprise at least one of Doppler measurements, pseudorange measurements, range measurements, or time of arrival (TOA) measurements.

3. The method of claim 1, wherein the navigation measurements comprise at least one of unvalidated navigation measurements or validated navigation measurements.

4. The method of claim 3, wherein at least one of the unvalidated navigation measurements or the validated navigation measurements are based on signals received from at least one of one or more satellites, one or more aircraft, one or more unmanned aerial vehicles (UAVs), one or more pseudo-satellites, one or more aerial balloons, or one or more terrestrial cellular towers.

5. The method of claim 3, wherein the unvalidated navigation measurements are based on signals received from one or more satellites in a first constellation of satellites, and the validated navigation measurements are based on signals received from one or more satellites in a second constellation of satellites.

6. The method of claim 5, wherein the one or more satellites in the first constellation of satellites and the one or more satellites in the second constellation of satellites are within communication range of the navigation device at a same time.

7. The method of claim 5, wherein the one or more satellites in the first constellation of satellites are one of geosynchronous earth orbit (GEO) satellites, medium earth orbit (MEO) satellites, or low earth orbit (LEO) satellites, and
wherein the one or more satellites in the second constellation of satellites one of GEO satellites, MEO satellites, or LEO satellites.

8. The method of claim 3, wherein the unvalidated navigation measurements are based on signals received from one or more satellites within a same constellation of satellites.

9. The method of claim 3, further comprising detecting, by the navigation device, the errors, based on a comparison of a first estimated navigation solution for the navigation device with a second estimated navigation solution for the navigation device.

10. The method of claim 9, wherein the first estimated navigation solution and the second estimated navigation solution each comprise at least one of a position, timing, velocity, or attitude of the navigation device.

11. The method of claim 9, wherein the first estimated navigation solution is based on a first set of measurements comprising the validated navigation measurements and the unvalidated navigation measurements.

12. The method of claim 9, wherein the second estimated navigation solution is based on a second set of measurements comprising the unvalidated navigation measurements.

13. The method of claim 3, wherein the unvalidated navigation measurements are fully determined unvalidated navigation measurements, and the validated navigation measurements are underdetermined validated navigation measurements.

14. The method of claim 13, wherein the unvalidated navigation measurements and the validated navigation measurements are based on signals synchronized to a same clock.

15. The method of claim 13, wherein the unvalidated navigation measurements are based on signals synchronized to a first clock, and the validated navigation measurements are based on signals synchronized to a second clock.

16. The method of claim 15, further comprising determining, by the navigation device, timing of the first clock based on the unvalidated navigation measurements.

17. The method of claim 3, wherein the validated navigation measurements are fully determined validated navigation measurements with a high dilution of precision (DOP).

18. The method of claim 17, wherein the unvalidated navigation measurements and the validated navigation measurements are based on signals synchronized to a same clock.

19. The method of claim 3, wherein the unvalidated navigation measurements are underdetermined unvalidated navigation measurements, and the validated navigation measurements are underdetermined validated navigation measurements.

20. The method of claim 19, wherein the unvalidated navigation measurements and the validated navigation measurements are based on signals synchronized to a same clock.

21. The method of claim 1, wherein a first portion of the navigation measurements are based on signals synchronized to a first clock, and a second portion of the navigation measurements are based on signals synchronized to a second clock.

22. The method of claim 21, further comprising comparing, by the navigation device, the first portion of the navigation measurements that are based on the signals synchronized to the first clock with the second portion of the navigation measurements that are based on the signals synchronized to the second clock to determine a consistency with a known relative stability of the first clock and the second clock relative to each other.

23. The method of claim 21, further comprising comparing, by the navigation device, the first portion of the navigation measurements that are based on the signals synchronized to the first clock with the second portion of the navigation measurements that are based on the signals synchronized to the second clock to determine a consistency with a known receiver acceleration based on a motion sensor.

24. The method of claim 1, wherein the trusted navigation measurements comprise at least one of validated navigation measurements or local navigation measurements.

25. The method of claim 24, wherein the local navigation measurements comprise at least one of inertial measurements or barometric pressure measurements.

26. The method of claim 1, wherein the navigation solutions comprise at least one of unvalidated navigation solutions or validated navigation solutions.

27. The method of claim 1, wherein the navigation solutions comprise at least one of position, velocity, or attitude of the navigation device.

28. The method of claim 1, wherein the navigation data comprises at least one of unvalidated navigation data or validated navigation data.

29. The method of claim 1, wherein the navigation data comprises at least one of satellite ephemeris data, satellite orbit data, or satellite clock data.

30. The method of claim 1, wherein the errors indicate a spoofable subspace.

31. The method of claim 30, wherein the spoofable subspace is one of a line or a surface.

32. A system for navigation, the system comprising:
a navigation device configured to detect errors in at least one of navigation measurements, navigation solutions, or navigation data, based on trusted navigation measurements.

33. The system of claim 32, wherein the navigation measurements comprise at least one of unvalidated navigation measurements or validated navigation measurements.

34. The system of claim 33, wherein the navigation device is further configured to detect the errors, based on a comparison of a first estimated navigation solution for the navigation device with a second estimated navigation solution for the navigation device.

35. The method of claim 34, wherein the first estimated navigation solution and the second estimated navigation solution each comprise at least one of a position, timing, velocity, or attitude of the navigation device.

36. The method of claim 34, wherein the first estimated navigation solution is based on a first set of measurements comprising the validated navigation measurements and the unvalidated navigation measurements.

37. The method of claim 34, wherein the second estimated navigation solution is based on a second set of measurements comprising the unvalidated navigation measurements.
